(19) United States
(12) Patent Application Publication
(10) Pub. No.: US 2022/0133597 A1
(43) Pub. Date: May 5, 2022

(54) BABY BOTTLE RETAINING SLEEVE

(71) Applicant: Anjellica Williams, Orlando, FL (US)

(72) Inventor: Anjellica Williams, Orlando, FL (US)

(21) Appl. No.: 17/575,929

(22) Filed: Jan. 14, 2022

Related U.S. Application Data
(63) Continuation-in-part of application No. 16/903,298, filed on Jun. 16, 2020.

(51) Int. Cl. A61J 9/06

(52) U.S. Cl. CPC A61J 9/0661; A61J 9/0646

(57) ABSTRACT

A retaining device configured for securing a bottle. The retaining device includes a receptacle that is configured to receive a bottle. The receptacle includes a cylindrical wall portion that is configured to secure the bottle. The cylindrical wall portion further includes a six-leaf mouth opening that expands to accommodate different size bottles and provides a snug grip to bottles. The retaining device further includes a base and configured to create a wide suction base, that is extended out from the bottom portion of the cylindrical portion.

### CROSS-REFERENCE TO RELATED APPLICATIONS

This application claims the benefit of U.S. Provisional Application Ser. No. 62/862,111, titled “BABY BOTTLE HOLDER AND SLEEVE,” filed on Jun. 16, 2019, and U.S. non-provisional patent application Ser. No. 16/903,298. This application incorporates the entire contents of the foregoing applications herein by reference.

### FIELD OF THE INVENTION

The present invention is a baby bottle holder or sleeve that prevents a liquid substance from spilling. Specifically, the present invention is a baby bottle holder or sleeve that is configured to be attached to the base of the bottle to prevent the bottle from being knocked over, slipping out of a user's hand or the content's seen by the user.

### BACKGROUND

In today's society caretakers and parents are constantly looking for improved processes for providing care to baby's and infants alike. Accordingly, caretakers while preparing bottles with formula, breast milk, or any form of liquid formulation, run the risk of spilling the milk or liquid, ultimately wasting the child's nourishment. There are a variety of bottles that are often used in different sizes and shapes. However, breast pump compatible bottles mostly contain breast flange or shields on top, that are often too heavy and can cause the bottle to tip over. While on a flat surface, bottles run the risk of falling over because the top part of the bottles is too heavy, due to the bottom being unstable. In some instances, while transferring milk from breast milk storage bags to bottles, or transferring milk between bottles, there can be a loss of milk due to the result of spilled milk or a bottle that was inadvertently bumped.

There are also risks of experiencing anxiety from being able to visually see the contents of the bottle. Mothers who are actively breastfeeding often may feel anxiety or pressure from seeing the milk contents drip into the bottle or retaining device. Studies have shown that by not seeing the milk drip, breastfeeders can remain calm and have a better output of milk.

Additionally, young children, particularly infants and toddlers, tend to touch, move, and knock over almost anything in their possession. Part of the reason is that they are still learning their motor functions. Another reason is that they are being adventurous, explorative, and learning their abilities from a cause-and-effect standpoint. Naturally, parents often attempt to provide safe items, and areas for the baby to interact with and within. Often this is a tough task as baby's and infants alike naturally look to chew, touch, and play with any item within arm's reach. Accordingly, most items end up being knocked over, dropped, or tossed during their interactions with these items.

This tends to be quite cumbersome for parents as they look to defend, protect, and ensure that their child remains unharmed, and away from risky scenarios. Additionally, parents are often having to constantly pick things up from off the ground and return them to the baby. Additionally, often parents will need to sanitize and clean the objects before handing them back to the child to avoid them contacting any unnecessary germs. Babies and toddlers are also learning how to move their bodies effectively for transportation, but early on, they do not have the coordination to do this smoothly and often tip over or fall when they are trying to reach for something that is out of reach.

Circumventing many of the above-described problems is especially challenging for a caregiver or parents alike. This is especially true about cups, bottles, and sippy cups. These items are often mishandled, bumped, accidentally dropped, or intentionally and repeatedly thrown to the ground.

As such, there is an ongoing need for a baby bottle holder or sleeve that is configured to be attached to the base of the bottle to prevent the bottle from being knocked over or slipping out of a user's, baby, or infant's hands.

Embodiments of the invention, on the other hand, provide significant advantages while overcoming the above-described and other disadvantages, as will now be described.

### SUMMARY

To provide a solution to the above-described issues, a baby bottle holder or sleeve that is configured to be attached to the base of the bottle to prevent the bottle from being knocked over or slipping out of a user's hand is described.

In one aspect of the invention, a holder device is disclosed. The holder device includes a suction device, configured to create a vacuum on a fixed surface, resulting in being affixed to the fixed surface. The holder device includes a base member configured to provide leveling support to an article. The holder device includes a hollowed-out portion centrally positioned on the base member and extending in an upward direction. The holder device includes a grip positioned within the inner periphery of the hollowed-out portion, configured to prevent the article from inadvertent slipping.

In one embodiment, the cylindrical wall portion comprises a six-leaf mouth opening configured to expand to accommodate different size bottles.

In one embodiment, the six-leaf mouth opening comprises of a shaped inner periphery and a cylindrical outer periphery.

In one embodiment, the suction device is configured to be flush with the outer periphery of the base member.

In one embodiment, the base member is planar and configured to be adapted to be placed on a flat fixed surface.

In one embodiment, the hollowed-out portion is a cylindrical shape.

In one embodiment, the hollowed-out portion comprises of walls configured to contact all sides of an article.

In one embodiment, the hollowed-out portion comprise of gripping devices on one or more outer periphery walls, preventing slippage from a user's hand.

In one embodiment, the article is one or more of cups, bottles and sippy cups.

In one embodiment, the suction device comprises of a suction release device, configured to release the vacuum created with the fixed surface.

In one embodiment, the suction release device is a tab, configured to release the suction.

In one embodiment, a peep hole is provided in the hollowed-out portion, configured to allow a user to see the amount of substance within the article.

In one embodiment, the amount of substance within the article is in milliliters (mL) or ounces (oz).

This Summary is provided merely for purposes of summarizing some example embodiments, to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of apparatuses, methods, and systems pertaining to a baby bottle holder or sleeve. This description includes drawings, wherein:

FIG. 1 is a side perspective view of a baby bottle holder or sleeve, in accordance with an example;

FIG. 2 is a cross sectional view of a baby bottle holder or sleeve, in accordance with an example;

FIG. 3 is a bottom view of the baby bottle holder device, in accordance with an example;

FIG. 4 is a top perspective view of a baby bottle holder or sleeve, in accordance with an example;

FIG. 5 is a perspective view of a baby bottle holder or sleeve, in accordance with an example; and

FIG. 6 is a side/bottom perspective view of a baby bottle holder or sleeve, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is to describe particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

An article holder device, is disclosed. The holder device includes a suction device, configured to create a vacuum on a fixed surface, resulting in being affixed to the fixed surface. The holder device includes a base member configured to provide leveling support to an article. The holder device includes a hollowed-out portion centrally positioned on the base member, and extending in an upward direction. The holder device includes a grip positioned within the inner periphery of the hollowed-out portion, configured to prevent the article from inadvertent slipping.

Accordingly, the present disclosure provides, in a preferred embodiment, a baby bottle holder that suctions to surfaces. It holds the bottle in place and decreases the scenarios of spilling milk or different types of liquid. It provides stability while preventing bottles from being tipped or knocked over. The six-leaf mouth opening expands to accommodate different size bottles and also provides a snug grip to bottles. The bottle holder is attached to the base of bottles because many bottles have a heavy top and unstable based.

In another embodiment of the invention, the disclosure provides for a retaining device configured for securing a bottle. The retaining device includes a receptacle that is configured to receive a bottle. The receptacle includes a cylindrical wall portion that is configured to secure the bottle. The cylindrical wall portion further includes a six-leaf mouth opening that expands to accommodate different size bottles and provides a snug grip to bottles. The retaining device further includes a base and configured to create a wide suction base, that is extended out from the bottom portion of the cylindrical portion.

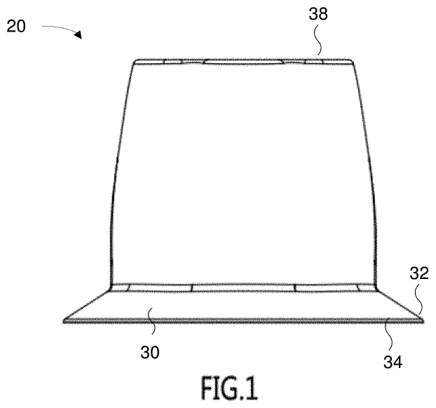

FIG. 1 is a side perspective view of a baby bottle holder or sleeve, in accordance with an example. The baby holder can be a bottle holder 20, that is configured to hold a baby bottle, or another device configured for baby liquid consumption. The bottle holder 20, comprises an inner base 30, that provides leveling support to a liquid consumption device. The inner base 30 is attached to an underneath suction device 34, configured to create a vacuum on a fixed surface, resulting in being affixed to the fixed surface. The underneath suction device is configured to have an outer edge that extends outward from the bottom portion of the inner base 30, creating a stable wide external base that allows for stability relative to the weight of the baby bottle and its contents. The top portion 38 of the bottle holder 20 is configured to be narrower than the bottom portion of the bottle holder 20. The narrowness of the top portion allows for a bottle to be secured through pressure created by the top portion 38 contacting a top portion of a bottle, preventing the bottle from slipping from the bottle holder 20.

Leading from the base 30 in an upward direction is a plurality of outside walls 40, which form a hollowed-out portion for withholding a liquid consumption device. The liquid consumption device is configured to slide or fit within the outer mouth opening 38, to be secured within the hollowed-out portion. The outer mouth opening 38 is configured to expand to accommodate different size bottles.

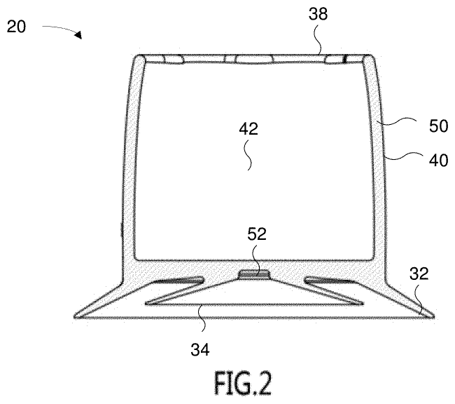

FIG. 2 is a cross sectional view of a baby bottle holder or sleeve, in accordance with an example. The bottle holder 20 includes an insulated material 50 that includes a density that is configured for retaining a bottle upright within the inner walls 42 of the bottle holder 50. The insulated material 50 is configured to retain a constant temperature of the bottle while retaining the contents of the bottle. As further shown in FIG. 2, in some examples, the suction device 34 is configured to be flush with the inner base 30, to ensure full coverage and stability for the liquid consumption device held within the whole-body holder 20. The suction device 34 further includes a central portion 52 that is configured to activate the suction of the suction device 34, when in a compressed downward position. Once the central portion is decompressed and in an upward position, the suction device 34 is then deactivated, thus releasing the base 32 from a fixed surface it is affixed to.

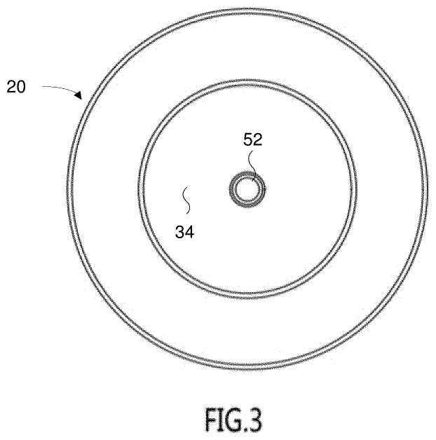

As shown in FIG. 3, the underneath suction 34 can be released from a fixed surface by lifting on the body of the bottle holder 20, which deactivates the central portion, and releases the suction 34. In essence, the suction 34 creates a vacuum on a fixed surface, around the outer edge of the base 32 which seals the surface, resulting in being affixed to the fixed surface.

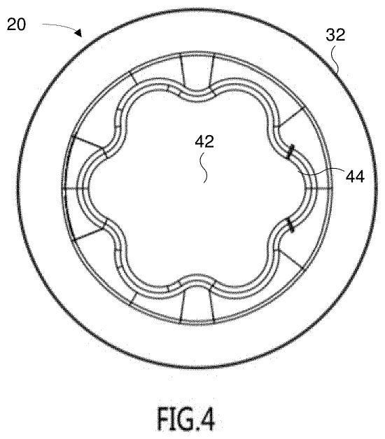

FIG. 4 is a top perspective view of a baby bottle holder or sleeve, in accordance with an example. FIG. 4 shows that the outer mouth opening 38, is constructed as a leaf mouth opening that expands to accommodate different size bottles and also provides a snug grip to bottles. Accordingly, the bottle holder is attached to the base of bottles because many bottles have a heavy top and unstable base.

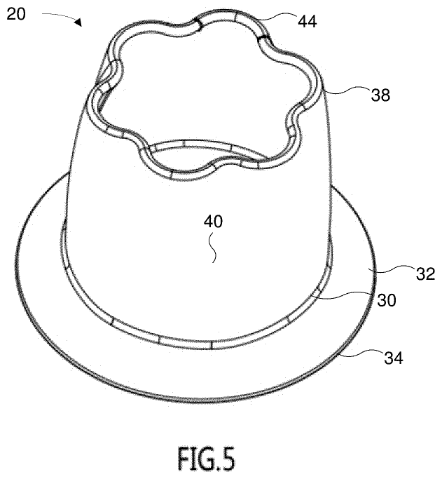

In reference to FIG. 5, the outside walls 40 are constructed with expandable material which allows for expansion when larger sized consumption devices are placed within the inner mouth 44 of the inside bottle holder 42. Once an article is placed within the inner mouth 44, the outside walls 40 fit snuggly around the outside of the article, providing a snug fit, tight stability, and allowing for enough stability to allow the underneath suction 34, to secure to a fixed or flat surface.

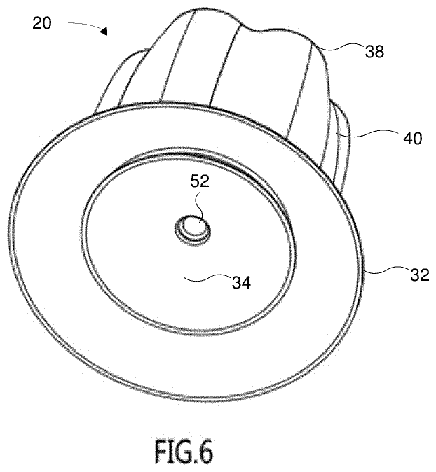

FIG. 6 is a side/bottom perspective view of a baby bottle holder or sleeve, in accordance with an example. FIG. 6 depicts a further indication of the underneath suction device, in accordance with a combination of the examples above.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A retaining device configured to secure a bottle, comprising:
a receptacle that is configured to receive a bottle, wherein the receptacle includes a cylindrical wall that is configured to secure the bottle on one or more sides of the bottle;
a base positioned on the bottom portion of the cylindrical wall, extended out from the bottom portion creating a wide base relative to the bottom portion of the cylindrical wall;
a suction device affixed to the base, wherein the suction device is configured to create a vacuum on a fixed surface;
a base member configured to provide leveling support to an article;
a hollowed-out portion centrally positioned on the base member, and extending in an upward direction, forming the cylindrical walls; and
a grip positioned within the inner periphery of the hollowed-out portion, configured to prevent the article from slipping.

2. The retaining device of claim 1, wherein the cylindrical wall portion comprises a six-leaf mouth opening configured to expand to accommodate different size bottles.

3. The retaining device of claim 2, wherein the six-leaf mouth opening comprises of a shaped inner periphery and a cylindrical outer periphery.

4. The retaining device of claim 1, wherein the suction device is configured to be flush with the outer periphery of the base member.

5. The retaining device of claim 1, wherein the base is configured to provide leveling support to a bottle positioned inside the cylindrical walls.

6. The retaining device of claim 1, wherein the base member is planar and configured to be adapted to be placed on a flat fixed surface.

7. The retaining device of claim 1, wherein the hollowed-out portion is a cylindrical shape.

8. The retaining device of claim 1, wherein the hollowed-out portion comprises of walls configured to contact all sides of an article.

9. The retaining device of claim 1, wherein the hollowed-out portion comprise of gripping devices on one or more outer periphery walls, preventing slippage from a user's hand.

10. The retaining device of claim 1, wherein the article is one or more of cups, bottles and sippy cups.

11. The retaining device of claim 1, wherein the suction device comprises of a suction release device, configured to release the vacuum created with the fixed surface.

12. The retaining device of claim 11, wherein the suction device further includes a central portion that is configured to activate the suction of the suction device.

13. The retaining device of claim 11, wherein the suction device is configured to be activated when in a compressed downward position.

14. The retaining device of claim 11, wherein the suction device is configured to be de-activated when in a decompressed upward position.

15. The retaining device of claim 1, wherein the suction release device is a tab, configured to release the suction.

16. The retaining device of claim 1, wherein a peep hole is provided in the hollowed-out portion, configured to allow a user to see the amount of substance within the article.

17. The retaining device of claim 1, wherein the amount of substance within the article is configured to be measured in milliliters (mL) and ounces (oz).

18. The retaining device of claim 1, wherein the receptacle is a sleeve for a baby bottle.
